(19) United States
(12) Patent Application Publication
(10) Pub. No.: US 2008/0281007 A1
(43) Pub. Date: Nov. 13, 2008

(54) Foamable Composition for Production of Foamed Plastics

(75) Inventor: Juergen Weidinger, Polling (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/093,107

(22) PCT Filed: Nov. 3, 2006
(86) PCT No.: PCT/EP2006/068065

§ 371 Date: May 8, 2008

(30) Foreign Application Priority Data
Nov. 10, 2005 (DE) 10 2005 053 697.2

(51) Int. Cl. C08J 9/06

(52) U.S. Cl. 521/84.1; 521/91

(57) ABSTRACT

Polymer foam compositions include as a blowing agent an inorganic or organic compound containing liquid of crystallization or intercalation. Foams of good physical properties can be obtained thereby.

The invention relates to foamable compositions, to their production, and to their use for the production of foamed plastics.

Foamed plastics items, and also corresponding blowing systems for foaming or expansion, have a long history of disclosure in the literature and in patents. Foaming is mainly used in this sector for weight reduction and to achieve new properties. In elastomer technology, an additional factor is increased compressibility. Elastomer foams are mostly produced by means of chemical blowing agents which by way of example liberate gases, such as nitrogen, oxygen, CO₂, hydrogen, and water vapor at an elevated temperature or as a result of addition of auxiliary substances. The expansion of elastomers naturally leads to a loss of mechanical strength. In many instances these materials can also only be used with particular crosslinking systems or formulations, or their use is subject to restrictions in relation to safety at work and to intended subsequent uses.

To obtain a foam with the best possible mechanical properties, i.e. with low compression set, and also high resistance for example with respect to temperature effects or chemicals, silicone elastomers are preferably used as underlying rubber. In relation to production of silicone foam, too, there has hitherto been no method, or only very unsatisfactory methods, for countering the abovementioned disadvantages or restrictions. The patent specification EP 0 751 174 B1, for example, describes the use of hollow gas-containing fillers. A disadvantage of these technologies is the collapse of the hollow cells on simultaneous exposure to heat and pressure, i.e. poor compression set.

Foaming is achieved by means of alcohol in the specification EP 0 506 241 B1 and by means of water in EP 0 553 889 B1. The two foaming agents have the disadvantage of being polar substances fundamentally incompatible with silicone. They therefore have to be emulsified in the elastomer matrix, and this leads to severe restrictions in relation to handling and stability, producing the mixing phenomena and inhomogeneity, for example.

Other blowing systems attended by the same problems, for example phosphines, are described, for example, in the patent specification EP 0 355 429 B1.

Hydrogen-based foams, as described by way of example in EP 0 416 229 A2, have very restricted use, since they have to be used in situ after mixing of the components. These foams can achieve low densities, but also have only low mechanical strengths.

The use of traditional, nitrogen-based blowing agents, such as azodicarbonamide and 2,2′-azobisisobutyronitrile AIBN, is moreover not considered to meet the objectives, because of toxicological considerations as by way of example described by Reinl, W., Erkrankungen durch Tetramethylbernsteinsauredinitril bei der Schaumstoffherstellung [Pathological effects of tetramethylsuccinonitrile in foam production], Archiv für Toxikologie, volume 16, page 367 380, 1957 and Azobisisobutyronitrile, Health Council of the Netherlands, 2002, Publication 2002/01 OSH, and also on grounds of mediocre compression set, as shown by example 8 in table 1 of this specification.

Finally, the literature mentions CO₂-forming foams based on the decomposition of carbonates, examples being the patent specifications DE 197 50 697 A1 and EP 0 751 173 B1. A disadvantage of these foams is either that the foam structure is inhomogeneous and not very reproducible or that a closed-cell foam is formed which by definition has a poorer compression set than open-pore foam whose primary properties are comparable.

It was therefore an object of the invention to provide a foamable composition which mitigates the abovementioned disadvantages or even eliminates them entirely, and which, by means of various extrusion and shaping processes, gives a plastics foam with low density and good mechanical strength.

This object was achieved via the incorporation of solvent-liberating compounds into the main plastics matrix. The invention therefore provides a foamable composition comprising
A) 100 parts of at least one plastics matrix selected from the group consisting of thermoplastics, thermosets, elastomers, and thermoplastic elastomers,
B) from 0.1 to 10 parts of at least one blowing agent selected from the group consisting of inorganic or organic compounds with the property of interacting with liquids.

The inventive foamable composition can moreover comprise
C) from 0 to 10 parts of further blowing agents, and
D) from 0 to 200 parts of further constituents selected from the group consisting of crosslinking agents, thickeners, retarders, catalysts, inhibitors, fillers, such as reinforcing and non-reinforcing fillers, plasticizers, adhesion promoters, soluble dyes, inorganic and organic pigments, solvents, fungicides, odorants, dispersing agents, rheology additives, corrosion inhibitors, oxidation inhibitors, light stabilizers, heat stabilizers, UV stabilizers, flame retardants, and agents affecting electrical properties, and mixtures of these.

Surprisingly, it has been found that the inventive foamable composition leads to uniform and very consistent expansion at temperatures starting at the boiling point of the liquid bound to the blowing agent B).

Any plastics that cure through temperature effects or can be subjected to temperature effects can be used as plastics matrix A) in the inventive foamable composition, i.e. any of the rubbers, and in the case of silicones either liquid silicones or solid silicones.

The plastics matrix A) preferably involves elastomers and particularly preferably involves silicone rubbers which crosslink at relatively high temperatures, preference being given here to silicone rubbers which crosslink at from 100 to 250° C.

The inventive blowing agents B) are preferably selected from the group consisting of crystalline, organic and inorganic compounds, non-crystalline complexing agents, and intercalate compounds.

Examples of inventive crystalline blowing agents B) are salts, such as Glauber's salt and Na₂SO₄. Inventive non-crystalline blowing agents B) typically exhibit layer structures with interstices, as is the case by way of example in phyllosilicates and kaolin. The character of the substrate permits the binding or embedment of polar liquids, such as water, or of liquids of relatively nonpolar type, an example being THF.

The liquid molecules bound to the blowing agent B) are selected from the group consisting of organic and inorganic solvents. These solvents are preferably selected from the group consisting of water, alcohol, amines, THF, pentane, hexane, toluene, and ethers, and mixtures of these. Water is particularly preferred liquid molecule.

There is a very wide variety of types of binding of the liquid molecules to the blowing agent, as a function of the character of the blowing agent B), examples being purely physical inclusion, adsorption, covalent bonding, complexing, or another type of chemical bonding.

Features shared by all of these liquids is their potential for volatility at relatively high temperatures, on breakdown of the lattice in the case of liquid of crystallization, and on reaching the energy threshold needed to overcome the binding forces in the case of intercalated liquid. This means that, given correct choice of the blowing agent B), foaming can be set to occur by way of example at the conventional temperatures for elastomer processing, normally from 100 to 200° C.

Given correct choice of these blowing agents B) comprising intercalated liquid or comprising liquid of crystallization, the result, when comparison is made with most known blowing agent systems, is many advantages for use in transparent or opaque compositions of plastics and of elastomers, and, given appropriate choice of the liquid, even in food-compatible compositions of plastics and of elastomers. Firstly, they have excellent mechanical strength, an example being the compression set in the case of rubbers, which exhibit very good resilience because of mixed-cell structure with a majority of open cells. The general stability of the inventive foamable composition is moreover high, since the non-volatile residues of the blowing agent B) are to a very large extent chemically inert and thus do not interact with the plastics matrix A). The materials can moreover be colored as desired, since they themselves are mostly colorless. There is no adverse effect on surface properties, for example grip, and, given an appropriate choice of the liquid, the materials are moreover suitable for foods and comply with the regulations of the BfR [German Federal Institute for Risk Assessment] or FDA. Safety aspects also favor the inventive foamable composition, since, given use of water as liquid, the composition does not promote the spread of fire and in the event of fire there is no formation of toxic combustion products. There is moreover no interaction with other constituents of the formulation in the foamable composition.

Preferred intercalated liquid and liquid of crystallization is water. Intercalated water or water of crystallization is water bound between the layers and, respectively, bound into the crystal structure, of organic or inorganic compounds, there being a very wide variety of binding ratios in these “hydrates”. Examples are hydrated zeolites, phyllosilicates, salts comprising water of crystallization, e.g. in the known material gypsum, and other examples are found in proteins, such as casein, and in traditional salts, such as sulfates and phosphates, e.g. Glauber's salt, Na₂SO₄×10H₂O, and also non-crystalline hydrated complex compounds.

There are no restrictions on the use of the inventive blowing agents B) in the plastics matrix A), since properties are retained in the foamed item. The European laid-open specifications EP 1 375 622 A1 and EP 1 266 948 A2 describe self-adhesive silicones, and the relevant parts of those disclosures are incorporated into this application by way of reference. No effect of the inventive blowing agents B) on these self-adhesive properties could be detected. On the contrary, all of the other blowing agents revealed in the prior art exhibit a discernible effect on the self-adhesive properties of said silicones.

A further advantage of the inventive blowing agents B) is their presence in the form of solid, which can be dispersed very easily and without additional auxiliary substances in the plastics matrix A). The blowing agents B) mixed into the material are stable and do not undergo any alteration over time, given correct storage.

The inventive foamable composition can moreover be used in any desired combination with known blowing agents, such as carbonates, nitrogen compounds, and water- and alcohol-based blowing agents, and the inventive foamable composition here improves the final properties of the foams. When mixed into the material, the blowing agents can therefore either take the form of a solid or have been previously dissolved or converted to a masterbatch, or they can be present directly within the matrix.

The methods for production, handling, and processing of the inventive foamable composition are those usual in plastics technology, and there is therefore no need for any specific equipment.

The present invention further provides a process for the production of the inventive foamable composition, which comprises, for the production of a sub-batch or batch, incorporating components B) to D) into the plastics matrix A) by kneading or by mixing.

The inventive foamable composition is used for the production of foams. The method of processing for the production of the inventive foams from the inventive foamable composition is likewise well known, and comprises shaping via free foaming, extrusion, and/or molding of the foamable composition. Examples of extrusion processes are extrusion, blowmolding, and calendering. Examples of methods for the molding process are injection molding, transfer molding, and compression molding.

The foams obtained by means of the inventive foamable composition feature a mixed-cell structure with good compression set, low densities, and good mechanical and chemical properties. For example, water absorption is less than that of the open-cell foam, and compression set is superior to that of a closed-cell foam.

### EXAMPLES

### Example 1

### Production of a Silicone Foam Extrudate Item

30 parts of hydrous technical NaHSO₄ and 10 parts of muscovite from Goodfellow Corp., Devon, USA, a phyllosilicate, and also 5 parts of sodium acetate as acid regulator for stabilizing the condensation of the layer-structure polysilicic acid are dispersed very finely in 50 parts of silicone polymer whose average chain length is 10 000 SiO units. Three parts of the dispersion are then kneaded into 100 parts of silicone matrix, composed of polymer and also of fumed silica as filler, by shearing the material, using a theoretical final hardness of 60 Shore A.

The mixture is catalyzed using 1 part of 2,4-dichlorobenzoyl peroxide and extruded using a standard extruder where the temperature of the heating channel is 230° C., and vulcanized.

The resultant extrudate is colorless and has, after heat-conditioning, a typical density around 0.5 g/cm³, and a typical compression set (heat-conditioned) of <15% (22 h at 150° C., 25% compression).

### Example 2

### Production of a Silicone Foam Molding

8 grams of pulverulent technical dextrose comprising water of crystallization from Merck KGaA, Darmstadt, Germany are dispersed finely in 100 ml of a low-viscosity silicone polymer whose molar mass is about 40 000 g/mol, from Wacker Chemie GmbH, Munich, Germany, on a roll at just above room temperature, using minimal gap and friction (1:1.3). The roll is then cooled and the dextrose mixture is mixed, at 3 mm gap width and friction 1:1.1, with 800 grams of catalyzed ready-to-use silicone rubber mixture ELASTOSIL® R plus 4001/40 from Wacker Chemie GmbH, Munich, Germany, for final hardness of 60 Shore A. Using an approximate under-capacity factor of 80%, the finished foam mixture is charged to a compression mold, which is closed and heated to 250° C. in an oven. The material is demolded after 10 min, and the flash is removed. The density of the foamed item after heat-conditioning is around 0.75 g/cm³ with approximate compression set (heat-conditioned) of <25% (22 h at 150° C., 25% compression).

### Example 3

### Production of a Silicone Foam Sheet

A foamable mixture is produced as in example 2. The mixture is calendered on the roll at a thickness of about 2 mm onto a polytetrafluoroethylene foil and then passed through a heating section at 220° C. The material is expanded freely and gives foam sheets with a coherent surface and approximate density of 0.5 g/cm³, and good compression set.

### Examples 4 to 8

### Measurement and Comparison of Compression Sets on Foam Extrudate Items

Five silicone rubber mixtures, examples 4, 5, 6 and 8 using ELASTOSIL® R 401/40, and example 7 using ELASTOSIL® R plus 4305/40, from Wacker Chemie GmbH, Munich, Germany, in each case comprising an underlying 40 Shore A rubber, vulcanization additives, and also, in example 4, emulsified water as blowing agent (by analogy with EP 0 553 889 B1), and in example 5 gas-filled hollow thermoplastics spheres (by analogy with EP 0 751 174 B1), and in examples 6 and 7 inventive blowing agent systems (by analogy with example 1 and example 2), and in example 8 commercially available AIBN from Merck KGaA, Darmstadt, Germany, were extruded in such a way as to produce ideally expanded 6 mm round-bead profiles, with variation of extrusion speed and temperature, and also of the geometry of the extruder die, in each case within the available processing latitude. The round beads are inserted, after heat conditioning (for 4 hours at 200° C.) or without heat conditioning, into a metal mold which on closure produces 30% compression of the foamed round beads. The mold is stored at 150° C. for 22 hours, and then depressurized, and the diameter of the profiles is determined again after cooling. This gives the residual deformation of the foamed part, termed compression set or CS. The CS results for the differently foamed but otherwise identical 40 Shore A silicone rubbers are given in table 1. The inventive examples 6 and 7 show a comparable or even better result than the prior-art examples 4, 5 and 8.

TABLE 1

| | CS, without heat- | CS, with heat- |
|---|---|---|
| Example | conditioning | conditioning |
| 4* | 20% | 15% |
| 5* | 56% | 30% |
| 6 | 14% | 10% |
| 7 | 22% | 13% |
| 8* | 40% | 28% |

*non-inventive

1.-7. (canceled)

8. A composition comprising
A) 100 parts of at least one plastics matrix selected from the group consisting of elastomers and silicone rubbers,
B) from 0.1 to 10 parts of at least one blowing agent, containing bound liquid in the form of liquid of crystallization or intercalated liquid, selected from the group consisting of salts, phyllosilicates, and dextrose.

9. The composition of claim 8, which comprises
C) from 0 to 10 parts of further blowing agents exclusive of blowing agent(s) B), and
D) optionally from 0 to 200 parts of further constituents selected from the group consisting of crosslinking agents, thickeners, retarders, catalysts, inhibitors, fillers, such as reinforcing and nonreinforcing fillers, plasticizers, adhesion promoters, soluble dyes, inorganic and organic pigments, solvents, fungicides, odorants, dispersing agents, rheology additives, corrosion inhibitors, oxidation inhibitors, light stabilizers, heat stabilizers, UV stabilizers, flame retardants, agents affecting electrical properties, and mixtures of these.

10. The composition of claim 8, wherein the liquids of crystallization or intercalated liquids are selected from the group consisting of water, alcohol, amines, THF, pentane, hexane, toluene, ethers, and mixtures thereof.

11. The composition of claim 9, wherein the liquids of crystallization or intercalated liquids are selected from the group consisting of water, alcohol, amines, THF, pentane, hexane, toluene, ethers, and mixtures thereof.

12. A process for the production of a composition of claim 8, comprising producing a sub-batch or batch by incorporating components B) to D) into the plastics matrix A) by kneading or by mixing.

13. A foam prepared from the composition of claim 8.
